(19) United States
(12) Patent Application Publication
(10) Pub. No.: US 2008/0034589 A1
(43) Pub. Date: Feb. 14, 2008

(54) Razor cartridge adapter

(76) Inventor: Matthew E. Nearing, Dallas, TX (US)

Correspondence Address: Matthew E. Nearing, 3504 Misty Meadow Drive, Dallas, TX, 75287, US

(21) Appl. No.: 11/502,766

(22) Filed: Aug. 11, 2006

(51) Int. Cl. B26B 21/00

(52) U.S. Cl. 30/32

(57) ABSTRACT

An adapter is provided for mating a razor handle assembly of a first type with a disposable razor cartridge of a second type. The razor handle assembly may be compatible with a legacy disposable razor cartridge system. The adapter allows a user to continue shaving with the legacy handle assembly while taking advantage of the improvements provided by new disposable razor cartridge technology. The razor handle assembly may be a universal razor handle assembly that is compatible with a plurality of adapter assemblies.

### BACKGROUND

1. Technical Field

The present application relates generally to disposable razor cartridges. More specifically, the present application is directed to an adapter for razor cartridges.

2. Description of Related Art

In the past, a shaving razor consisted of a handle and a razor head in the same assembly. The head of the assembly included a structure for holding one or more razor blades. When the blade became dull, the user would disassemble the head, remove the blade, replace the blade with a new blade, and reassemble the head. Since the shaving razor assembly itself was not replaced, the razor assembly was often made of a durable, attractive material, such as nickel or sterling silver, for example.

In the past, a father would make a special occasion of teaching his son how to shave his face, or a mother may teach her daughter how to shave her legs, for instance. This ritual would sometimes include teaching the son or daughter how to care for the razor. In fact, since the razor assembly was often made of a durable, attractive, and valuable material, a parent may hand the shaving razor down from generation to generation.

Razor manufacturers began offering disposable razors. A disposable razor assembly would typically be made mostly of plastic. The disposable razor would include the handle, head, and razor in a single assembly. When the blade(s) became dull, the user would simply dispose of the entire razor.

Next, razor manufacturers developed a disposable razor cartridge system. The companies provide a handle assembly with a connector on the end and a package of disposable razor cartridge assemblies. The disposable razor cartridge assembly resembles the head of a disposable razor. The disposable cartridge is typically made mostly of plastic and includes a structure for permanently holding one or more razor blades. The handle assembly is typically made of plastic or inexpensive metal materials.

The handle assembly has an actuator coupled to the connector. When the razor(s) in a cartridge become dull, the user simply manipulates the actuator to release the old cartridge and then attaches a new cartridge to the handle assembly. The user may then purchase packages of razor cartridges, rather than purchasing packages of entire disposable razors. Thus, the disposable razor cartridge system is more cost effective and efficient for the user.

As shaving system technology advances, razor manufacturers provide improved razor cartridge systems. For example, razor cartridge systems have advanced from one blade to two blades to three blades, and so on. Sometimes, a significant change in the cartridge assembly is accompanied by a new class of disposable cartridge system with a new type of connector between the handle assembly and the cartridge assembly. For example, a razor manufacturer may introduce a new disposable razor cartridge system when migrating from a two-blade cartridge to a three-blade cartridge. Typically, when a new disposable razor cartridge system is introduced, the connector on the handle assembly will not engage with the connector on the previous generation cartridge.

Disposable razor cartridge systems are available at general retailers, such as supermarkets, drug stores, and wholesalers. Higher end retailers carry high quality handle assemblies that are compatible with the disposable cartridge razor systems. Instead of being made with plastic and inexpensive metals, these high quality handle assemblies may be made with ivory, wood, nickel, sterling silver, or gold. These high quality handle assemblies may cost hundreds of dollars, or possibly even a thousand dollars or more.

The disposable cartridge razor systems available in stores are constantly changing. Therefore, a high quality handle assembly that is compatible with a current disposable cartridge razor system is at best a short-term investment, rather than a keepsake that can be handed down from generation to generation. Many people who would normally purchase a superior shaving product may be put off by the high cost coupled with the transitory nature of disposable cartridge razor systems.

### SUMMARY

The illustrative embodiments recognize the disadvantages of the prior art and provide an adapter for mating a razor handle assembly of a first type with a disposable razor cartridge of a second type. The razor handle assembly may be compatible with a legacy disposable razor cartridge system. The adapter allows a user to continue shaving with the legacy handle assembly while taking advantage of the improvements provided by new disposable razor cartridge technology. The razor handle assembly may be a universal razor handle assembly that is compatible with a plurality of adapter assemblies.

In one illustrative embodiment, a disposable cartridge razor system comprises a razor handle assembly having a connector of a first type configured to be engaged with a disposable razor cartridge of a first type. The disposable cartridge razor system may further comprise a disposable razor cartridge having a connector of a second type configured to be engaged with a handle assembly of a second type. The disposable cartridge razor system may further comprise an adapter assembly having a connector of a first type configured to be engaged with the razor handle and a connector of a second type configured to be engaged with the disposable cartridge.

In one exemplary embodiment, the adapter assembly comprises an actuator, wherein the actuator is configured to disengage the disposable razor cartridge when manipulated by a user. In another exemplary embodiment, the adapter assembly comprises an actuator, wherein the actuator is configured to disengage the razor handle assembly when manipulated by a user.

In yet another exemplary embodiment, the adapter assembly comprises a first actuator that is configured to disengage the disposable razor cartridge when manipulated by a user and a second actuator that is configured to disengage the razor handle assembly when manipulated by the user.

In a further exemplary embodiment, the razor handle assembly is a legacy razor handle assembly and wherein the disposable razor cartridge is not compatible with the legacy razor handle assembly. In a still further exemplary embodiment, the razor handle assembly is a universal razor handle assembly that is compatible with a plurality of adapter assemblies.

In another illustrative embodiment, an adapter for a disposable cartridge razor system comprises an assembly body configured to conjoin between a razor handle assembly and a disposable razor cartridge. The adapter further comprises a first connector of a first type configured to engage with the razor handle assembly and a second connector of a second type configured to engage with the disposable razor cartridge.

In one exemplary embodiment, the adapter further comprises an actuator that is configured to disengage the disposable razor cartridge when manipulated by a user. In another exemplary embodiment, the adapter further comprises an actuator that is configured to disengage the razor handle assembly when manipulated by a user. In a still further embodiment, the adapter further comprises a first actuator that is configured to disengage the disposable razor cartridge when manipulated by a user and a second actuator that is configured to disengage the razor handle assembly when manipulated by the user.

In another exemplary embodiment, the razor handle assembly is a legacy razor handle assembly and wherein the disposable razor cartridge is not compatible with the legacy razor handle assembly. In a further embodiment, the razor handle assembly is a universal razor handle assembly that is compatible with a plurality of adapter assemblies.

In a further illustrative embodiment, a method is provided for a disposable cartridge razor system. The method comprises providing an adapter assembly configured to conjoin between a razor handle assembly and a disposable razor cartridge. The adapter assembly comprises a first connector of a first type configured to engage with the razor handle assembly and a second connector of a second type configured to engage with the disposable razor cartridge. The method further comprises engaging the first connector with a connector of the razor handle assembly and engaging the second connector with a connector of the disposable razor cartridge.

In one exemplary embodiment, the adapter assembly further comprises an actuator configured to disengage the disposable razor cartridge when manipulated by a user, and the method further comprises manipulating the actuator to disengage the disposable razor cartridge. In another exemplary embodiment, the actuator is configured to disengage the razor handle assembly when manipulated by the user, and the method further comprises manipulating the actuator to disengage the razor handle assembly. In a further exemplary embodiment, the razor handle assembly comprises an actuator that is configured to disengage the razor handle assembly when manipulated by a user, and the method further comprises manipulating the actuator to disengage the razor handle assembly.

In another exemplary embodiment, the razor handle assembly is a legacy razor handle assembly. The disposable razor cartridge is not compatible with the legacy razor handle assembly. In a further exemplary embodiment, the razor handle assembly is a universal razor handle assembly that is compatible with a plurality of adapter assemblies.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIGS. 1A-1C are exemplary diagrams of current disposable cartridge razor systems;

FIGS. 2A and 2B are exemplary diagrams of a disposable cartridge razor system in accordance with an illustrative embodiment; and

FIG. 3 is an exemplary diagram of a disposable cartridge razor system with a universal handle assembly in accordance with an illustrative embodiment.

### DETAILED DESCRIPTION OF THE ILLUSTRATIVE EMBODIMENTS

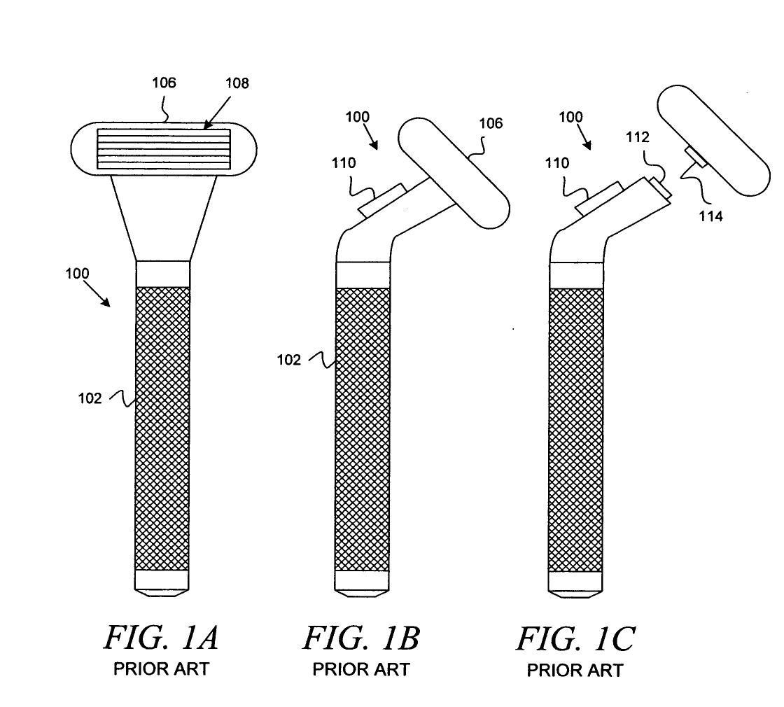

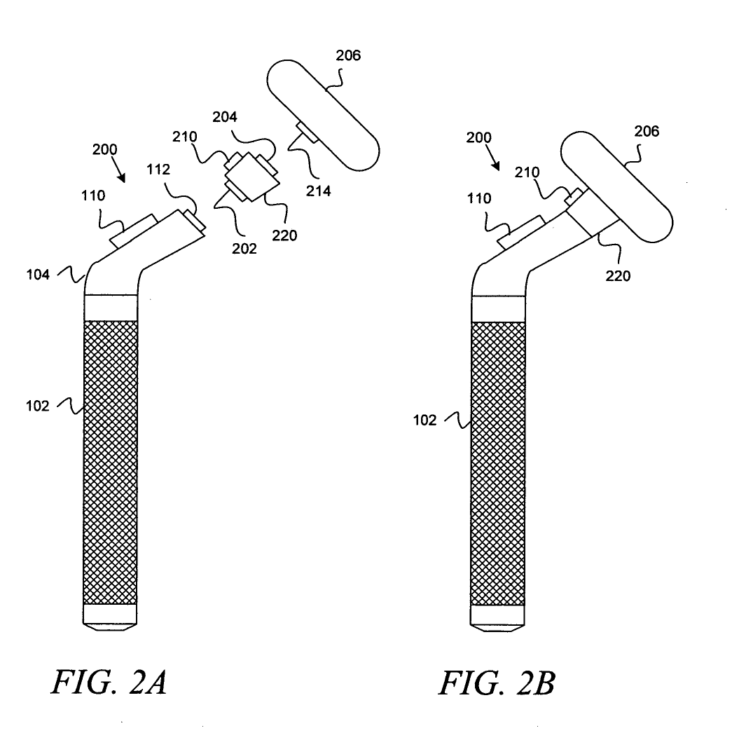

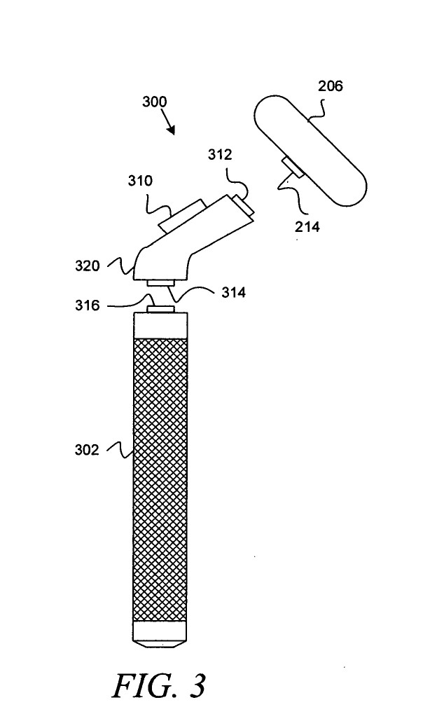

With reference now to the figures and in particular with reference to FIGS. 1A-1C, exemplary diagrams of current disposable cartridge razor systems are provided. FIGS. 2A, 2B, and 3 are exemplary diagrams of disposable cartridge razor systems in which exemplary aspects of the illustrative embodiments may be implemented. It should be appreciated that FIGS. 2A, 2B, and 3 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIGS. 1A-1C are exemplary diagrams of current disposable cartridge razor systems. More particularly, with reference to FIG. 1A, disposable cartridge razor system 100 comprises handle assembly 102 and disposable razor cartridge 106. Disposable cartridge 106 forms a head of disposable cartridge razor system 100. Disposable cartridge 106 has one or more blades 108.

FIG. 1B illustrates a side view of disposable cartridge razor system 100. Disposable razor cartridge 106 is attached to blade assembly 102. Actuator 110, when activated, releases disposable cartridge 106.

FIG. 1C depicts disposable cartridge razor system 100 with disposable blade cartridge 106 detached. Actuator 110 causes connector 112 on handle assembly 102 to disengage from connector 114 on disposable cartridge 106. Connector 112 and connector 114 are designed to engage when actuator 110 is not activated. Actuator 110 may be, for example, a button, lever, or the like. The manner in which connector 112 and connector 114 engage and the manner in which actuator 110 causes connector 112 and connector 114 to disengage are generally known in the prior art. However, connector 112 and connector 114 are typically unique for a particular class of disposable cartridge razor system.

As an example, the Gillette® Mach3® blade cartridge will not work with the Gillette® Sensor® handle assembly. As a further example, the Gillette® Fusion® blade cartridge will not work with a Schick® Quattro® blade cartridge will not work with the Gillette® Mach3® handle assembly. However, a disposable cartridge will usually work with a handle assembly within the same class. For example, a Gillette® Mach3Turbo® disposable blade cartridge will work with a Gillette® Mach3® handle assembly. “GILLETTE,” “SENSOR,” “MACH3,” and “FUSION” are registered trademarks of Procter & Gamble in the United States, other countries, or both. “SCHICK” and “QUATTRO” are registered trademarks of Eveready Battery Company, Inc. in the United States, other countries, or both.

Each new class of disposable cartridge razor system brings purported improvements in the shaving systems themselves. The manufacturers claim that added blades result in a closer shave in fewer strokes. Some disposable cartridge systems provide a pivoting head, spring-mounted blades, or a lubricating strip.

However, these improvements often come at a price. With each major advancement in disposable razor cartridge technology, the customer is asked to purchase a new handle assembly and new packs of disposable cartridges. If a handle assembly costs $10 or more, for example, then the expense may be a cost that the customer will bear, albeit grudgingly. Even at a low cost, however, such a burden may bring resentment. Customers may become suspicious that companies introduce a new line of disposable cartridges just to add a new product to the market, perhaps to fleece the buying public.

If a customer has purchased a high end razor handle assembly, then the burden of upgrading to a new class of disposable cartridges may be quite unwelcome. A customer may become infuriated to find that a beautiful sterling silver razor handle assembly that cost over $500, for instance, will not work with a new class of disposable cartridges within months of the purchase. In fact, many customers may balk at the idea of spending a large sum of money on a luxurious razor handle assembly knowing the transitory nature of the disposable cartridge razor system market.

In accordance with an illustrative embodiment, an adapter is provided for mating a razor handle assembly of a first type with a disposable razor cartridge of a second type. In one exemplary embodiment, the razor handle assembly is compatible with a legacy disposable razor cartridge system. The adapter allows a user to continue shaving with the legacy handle assembly while taking advantage of the improvements provided by new disposable razor cartridge technology.

FIGS. 2A and 2B are exemplary diagrams of a disposable cartridge razor system in accordance with an illustrative embodiment. With reference to FIG. 2A, disposable cartridge razor system 200 comprises handle assembly 102 and disposable razor cartridge 206. In the depicted example, handle assembly 102 is the same handle assembly shown in FIGS. 1A-1C; however, disposable razor cartridge 206 is of a different class. For example, handle assembly 102 may be compatible with a legacy disposable cartridge razor system while disposable cartridge 206 may be a newer disposable cartridge. Thus, connector 112 will not engage with connector 214.

Adapter 220 includes an adapter body that conjoins between handle assembly 102 and disposable cartridge 206. Connector 202 of adapter 220 is configured to engage with connector 112 of handle assembly 102. Connector 204 of adapter 220 is configured to engage with connector 214 of disposable cartridge 206.

FIG. 2B depicts a side view of disposable cartridge razor system 200. When adapter 220 is engaged with handle assembly, the user may release adapter 220 by manipulating actuator 110. When adapter 220 is engaged with disposable cartridge 206, the user may disengage the adapter and cartridge by manipulating actuator 210. Similar to actuator 110, actuator 210 may be, for example, a button, lever, or the like.

Thus, given adapter 220, a user may continue to use a high end, or even generally available, razor handle assembly with new generations of disposable cartridges. Each time a new class of disposable cartridges is introduced, the user may simply buy a new adapter, which is much more cost effective and convenient than buying an entire razor handle assembly.

FIG. 3 is an exemplary diagram of a disposable cartridge razor system with a universal handle assembly in accordance with an illustrative embodiment. Disposable cartridge razor system 300 comprises handle assembly 302 and disposable razor cartridge 306. In the depicted example, handle assembly 302 is a universal handle assembly that is designed to work with an adapter to engage with any class of disposable razor cartridge. That is handle assembly 302 has connector 316, which is of a generic type specifically configured to be engaged with adapter 320. That is, connector 316 of universal razor handle 302 is configured to engage with connector 314 of adapter 320. As stated above, the manner in which connectors engage and disengage is generally known in the prior art and not a focus of the instant disclosure.

Adapter 320 includes an adapter body that conjoins between handle assembly 302 and disposable cartridge 306. Connector 314 of adapter 320 is configured to engage with connector 316 of universal handle assembly 302. Connector 312 of adapter assembly 320 is configured to engage with connector 318 of disposable cartridge 306.

Actuator 310 is configured to release disposable cartridge 306 when manipulated by the user. In one illustrative embodiment, actuator 310 may be configured to also disengage adapter 320 from universal handle assembly 302. For example, actuator 310 may be a button assembly and adapter 320 may disengage from both handle assembly 302 and disposable cartridge 306 when depressed by the user.

In a further exemplary embodiment, adapter 320 may include two such actuators (second actuator not shown) for separately disengaging handle assembly 302 and cartridge 306. In a still further exemplary embodiment, handle assembly 302 may include an actuator (not shown) for disengaging handle assembly 302 from adapter assembly 320.

Thus, given universal razor handle 302 and adapter 320, a user may purchase a high end razor handle assembly knowing that only an inexpensive adapter will be needed to make the handle assembly compatible with new generations of disposable cartridges. Each time a new class of disposable cartridges is introduced, the user may simply buy a new adapter, which is much more cost effective and convenient than buying an entire razor handle assembly.

Those of ordinary skill in the art will appreciate that the hardware in FIGS. 2A, 2B, and 3 may vary depending on the implementation. The disposable razor cartridge adapter assemblies of the illustrative embodiments may be applied to any known or future disposable razor cartridge systems without departing from the spirit and scope of the present invention.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A disposable cartridge razor system, comprising:
a razor handle assembly having a connector of a first type configured to be engaged with a disposable razor cartridge of a first type;
a disposable razor cartridge having a connector of a second type configured to be engaged with a handle assembly of a second type; and
an adapter assembly having a connector of a first type configured to be engaged with the razor handle and a connector of a second type configured to be engaged with the disposable cartridge.

2. The disposable cartridge razor system of claim 1, wherein the adapter assembly comprises an actuator, wherein the actuator is configured to disengage the disposable razor cartridge when manipulated by a user.

3. The disposable cartridge razor system of claim 1, wherein the adapter assembly comprises an actuator, wherein the actuator is configured to disengage the razor handle assembly when manipulated by a user.

4. The disposable cartridge razor system of claim 1, wherein the adapter assembly comprises a first actuator that is configured to disengage the disposable razor cartridge when manipulated by a user and a second actuator that is configured to disengage the razor handle assembly when manipulated by the user.

5. The disposable cartridge razor system of claim 1, wherein the razor handle assembly is a legacy razor handle assembly and wherein the disposable razor cartridge is not compatible with the legacy razor handle assembly.

6. The disposable cartridge razor system of claim 1, wherein the razor handle assembly is a universal razor handle assembly that is compatible with a plurality of adapter assemblies.

7. An adapter for a disposable cartridge razor system, comprising:
an assembly body configured to conjoin between a razor handle assembly and a disposable razor cartridge;
a first connector of a first type configured to engage with the razor handle assembly; and
a second connector of a second type configured to engage with the disposable razor cartridge.

8. The adapter of claim 7, further comprising:
an actuator, wherein the actuator is configured to disengage the disposable razor cartridge when manipulated by a user.

9. The adapter of claim 7, further comprising:
an actuator, wherein the actuator is configured to disengage the razor handle assembly when manipulated by a user.

10. The adapter of claim 7, further comprising:
a first actuator that is configured to disengage the disposable razor cartridge when manipulated by a user; and
a second actuator that is configured to disengage the razor handle assembly when manipulated by the user.

11. The adapter of claim 7, wherein the razor handle assembly is a legacy razor handle assembly and wherein the disposable razor cartridge is not compatible with the legacy razor handle assembly.

12. The adapter of claim 7, wherein the razor handle assembly is a universal razor handle assembly that is compatible with a plurality of adapter assemblies.

13. A method for a disposable cartridge razor system, comprising:
providing an adapter assembly configured to conjoin between a razor handle assembly and a disposable razor cartridge, wherein the adapter assembly comprises a first connector of a first type configured to engage with the razor handle assembly and a second connector of a second type configured to engage with the disposable razor cartridge;
engaging the first connector with a connector of the razor handle assembly; and
engaging the second connector with a connector of the disposable razor cartridge.

14. The method of claim 13, wherein the adapter assembly further comprises an actuator configured to disengage the disposable razor cartridge when manipulated by a user, the method further comprising:
manipulating the actuator to disengage the disposable razor cartridge.

15. The method of claim 13, wherein the actuator is configured to disengage the razor handle assembly when manipulated by the user, the method further comprising:
manipulating the actuator to disengage the razor handle assembly.

16. The adapter of claim 13, wherein the razor handle assembly comprises an actuator that is configured to disengage the razor handle assembly when manipulated by a user, the method further comprising:
manipulating the actuator to disengage the razor handle assembly.

17. The method of claim 13, wherein the razor handle assembly is a legacy razor handle assembly and wherein the disposable razor cartridge is not compatible with the legacy razor handle assembly.

18. The method of claim 13, wherein the razor handle assembly is a universal razor handle assembly that is compatible with a plurality of adapter assemblies.
